(19) United States
(12) Patent Application Publication
(10) Pub. No.: US 2011/0085089 A1
(43) Pub. Date: Apr. 14, 2011

(54) APPARATUS AND METHOD FOR REMOTE CONTROL IN HOME NETWORK

(75) Inventor: Byeong-Woo Jung, Yongin-si (KR)

(73) Assignee: SAMSUNG ELECTRONICS CO. LTD., Suwon-si (JP)

(21) Appl. No.: 12/900,732

(22) Filed: Oct. 8, 2010

(30) Foreign Application Priority Data
Oct. 9, 2009 (KR) 10-2009-0096251

(51) Int. Cl. H04N 5/44

(52) U.S. Cl. 348/734; 348/E05.096

(57) ABSTRACT

A master Audio/Video (AV) device and at least one slave AV device based on a Multimedia over Coax Alliance (MoCA) network remotely control a state of each other. Thus, the at least one slave AV device can share the contents stored in the master AV device. The at least one slave AV device controls an operating state of the master AV device in a remote place, allowing a subscriber to more easily enjoy the contents stored in the master AV device.

### PRIORITY

This application claims the benefit under 35 U.S.C. §119(a) of a Korean patent application filed in the Korean Intellectual Property Office on Oct. 9, 2009 and assigned Serial No. 10-2009-0096251, the entire disclosure of which is hereby incorporated by reference.

### BACKGROUND OF THE INVENTION

1. Field of the Invention

The present invention relates to an apparatus and method for remote control in a home network. More particularly, the present invention relates to an apparatus and method for sharing content data using remote control.

2. Description of the Related Art

In general, a home network refers to a network implemented to enable communication between electronic devices installed in a home, using a specific communication scheme. The communication scheme may include both a wired communication scheme using a coaxial cable or the like, and a wireless communication scheme using Bluetooth, Infrared Data Association (IrDA), Radio Frequency Identification (RF ID), etc.

Multimedia over Coax Alliance (MoCA) is a type of home network technology now under standardization. The MoCA is a solution for globally switching the cable, satellite, Internet Protocol (IP)-network service providers to whole-home media distribution networks based on the existing coaxial connection between subscribers.

More particularly, a network supporting MoCA (hereinafter, a MoCA network) may provide a function in which subscribers securely access, store and share various digital multimedia contents, including High Definition Television (HDTV) programs, Video-on-Demand (VoD), Digital Video Recorder (DVR), Internet contents, videos, music, photos, Voice over IP (VoIP), and the like. That is, in the MoCA network, upon receiving a desired content from a content providing server, a media center not only can store and manage the received content and maintain a digital right thereof, but also can allow the content to be shared by other media applications in the home.

Therefore, MoCA not only satisfies the increasing demand for a whole-home DVR service, but also facilitates cost savings and easy installation and even provides consumer features of displaying and storing digital contents.

The MoCA network providing the above conveniences connects subscriber terminals installed in different locations. The subscriber terminals may include TVs installed in different locations in a home such as a living room, a media room, and a bedroom, and set-top boxes installed in their TVs. The set-top boxes constituting the subscriber terminals are classified into a master set-top box and a plurality of slave set-top boxes.

The master set-top box has a Hard Disk Drive (HDD) to store various content data received from the outside, and may provide the stored content data to the plurality of slave set-top boxes. The slave set-top box requests the master set-top box to provide the content data the subscriber wants to view, and receives the requested content data from the master set-top box.

Conventionally, however, there was no way for the slave set-top box to remotely control an operation of the master set-top box. Accordingly, if necessary, a subscriber using the slave set-top box must go to the location where the master set-top box is installed, and directly manipulate the master set-top box.

In particular, if the master set-top box is powered off, the slave set-top box cannot access any contents stored in the master set-top box until the master set-top box is powered on.

Therefore, in the MoCA network, for the convenience of subscribers, a method should be provided for remotely controlling an operation of the master set-top box using the slave set-top box.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for allowing an electronic device having the right of a slave to remotely control an electronic device having the right of a master in a home network.

Another aspect of the present invention is to provide an apparatus and method for allowing a subscriber terminal having the right of a slave to remotely control a subscriber terminal having the right of a master in a MoCA network.

Another aspect of the present invention is to provide an apparatus and method for allowing a subscriber terminal having the right of a slave to remotely control an operating state (or operating mode) of a subscriber terminal having the right of a master in a MoCA network.

Another aspect of the present invention is to provide an apparatus and method for allowing a subscriber terminal having the right of a slave to receive desired content data from a subscriber terminal having the right of a master by remotely controlling an operating state of the subscriber having the right of a master in a MoCA network.

Another aspect of the present invention is to provide an apparatus and method in which a subscriber terminal having the right of a slave switches an operating state of an inactivated subscriber terminal having the right of a master to an active state in a MoCA network.

In accordance with an aspect of the present invention, a method for remotely controlling a master subscriber terminal by a slave subscriber terminal in a home network is provided. In the method, the slave subscriber terminal requests the master subscriber terminal to switch to an active state upon receiving a content request command input by a user while recognizing that the master subscriber terminal is not in an active state. The slave subscriber terminal provides the user with a content list based on content information provided from the master subscriber terminal and receives content data, corresponding to a specific content selected by the user, from the master subscriber terminal.

In accordance with another aspect of the present invention, a home network system including at least one slave subscriber terminal and a master subscriber terminal is provided. The system includes a master subscriber terminal for identifying a state of at least one slave subscriber terminal, and, if the at least one slave subscriber terminal is in a standby state, for switching the state of the slave subscriber terminal to an active state and transmitting its state information and a content list. The system also includes the at least one slave subscriber terminal for requesting the master subscriber terminal to switch to an active state upon receiving a content request command input by a user while recognizing that the master subscriber terminal is not in the active state, for providing the user with a content list provided from the master subscriber terminal, and for receiving content data corresponding to a specific content selected by the user, from the master subscriber terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 schematically shows a configuration of a Multimedia over Coax Alliance (MoCA)-based broadcast system according to an exemplary embodiment of the present invention;

FIG. 2 shows a configuration of in-home Audio/Video (AV) devices communicating with each other over a MoCA network according to an exemplary embodiment of the present invention;

FIG. 3 is a flowchart showing an operation of a master AV device according to an exemplary embodiment of the present invention;

FIG. 4 is a flowchart showing an operation of a slave AV device according to an exemplary embodiment of the present invention; and

FIG. 5 is a flowchart showing an operation of a slave AV device according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Generally, an operating state (or operating mode) of an Audio/Video (AV) device can be roughly divided into two states: an active state (or active mode) in which the AV device can normally operate and an inactive state (inactive mode) in which the AV device cannot normally operate. The AV device switches to a standby state or a standby mode if no operation request has been received from a user for a predetermined time after the AV device is powered on. This state may be considered the inactive state.

The AV device merely maintains the minimum operation in the inactive state, and should necessarily switch to the active state to support its normal operation. Therefore, in order for the AV device to switch from the inactive state to the active state, a separate state transition operation should be performed in advance.

To this end, in a below-described exemplary embodiment of the present invention, to make use of a specific electronic device based on a home network, a method is provided for switching an operating state of the specific electronic device through remote control between electronic devices. More particularly, an exemplary embodiment of the present invention provides a method for enabling AV devices to share content data by remotely controlling operating states of subscriber terminals or AV devices being operated in a Multimedia over Coax Alliance (MoCA) network.

Now, a description will be made of structures of a broadcast system and a MoCA network, to which an exemplary embodiment of the present invention is to be applied, and operations of a master AV device and a slave AV device in the MoCA network.

Exemplary embodiments of the present invention will now be described with reference to the accompanying drawings.

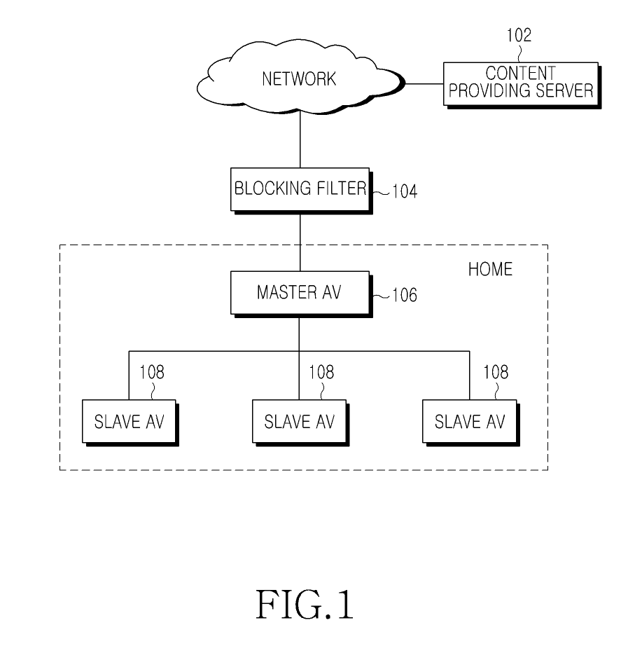

FIG. 1 schematically shows a configuration of a MoCA-based broadcast system according to an exemplary embodiment of the present invention.

Referring to FIG. 1, a broadcast system may be divided into an external network and an in-home MoCA network by a blocking filter 104.

The external network and the MoCA network operate in different frequency bands. Hence, the blocking filter 104 prevents a MoCA signal that is used in the home from being emitted to the external network.

A plurality of AV devices 106 and 108 perform interactive communication with each other in the MoCA network. The AV devices 106 and 108 commonly include one master AV device 106 and at least one slave AV device 108. A set-top box may be a typical example of the AV devices used in home. The set-top box is adapted to receive contents provided from a content providing server 102, and provide the received contents to a subscriber. The contents provided from the content providing server 102 may include terrestrial broadcast, cable broadcast, IP broadcast, satellite broadcast, and the like. The AV devices 106 and 108 may be installed in different locations in the home, such as a living room, a media room and a bedroom. Thus, a user may enjoy broadcast and multimedia services on the AV devices 106 and 108 situated in different locations in the home.

The master AV device 106 is connected to an external network via the blocking filter 104. The master AV device 106 is also connected to the slave AV devices 108 in the in-home MoCA network, and performs interactive communication with them. The master AV device 106 having a Hard Disk Drive (HDD) can store various contents received from the external network.

The at least one slave AV device 108 may share contents stored in the master AV device 106 over the MoCA network. In order for the slave AV device to access the contents stored in the master AV device, the master AV device should be in an active state or an active mode.

That is, according to the related art, in order for the slave AV device to access the contents, the master AV device in a remote location should be manually powered on. So, to enjoy the contents, the user should go to the location of the master AV device and power on the master AV device. However, this causes the user to experience an inconvenience. To address this inconvenience to the user, there is a need to perform remote control between the master AV device and the slave AV device.

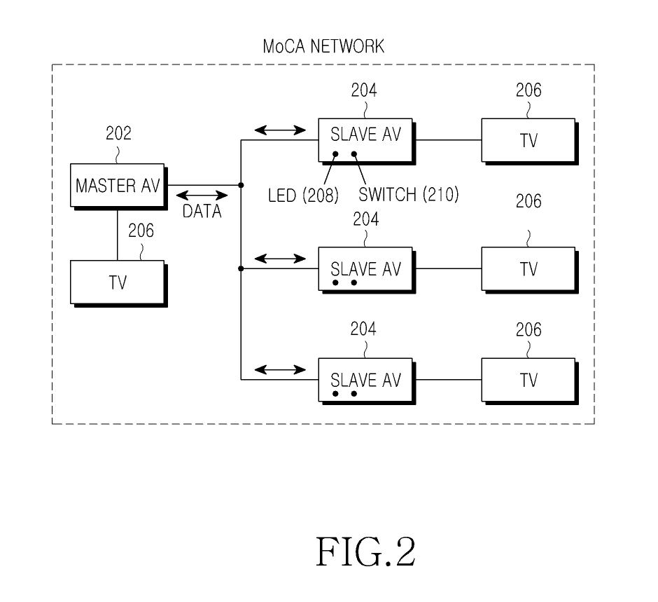

FIG. 2 shows a configuration of in-home AV devices communicating with each other over a MoCA network according to an exemplary embodiment of the present invention.

Referring to FIG. 2, the MoCA network includes a master AV device 202, slave AV devices 204, TVs 206, and a coaxial cable network connecting the master AV device 202 to the slave AV devices 204.

Users may obtain information about broadcast programs and search for program-related information, using an Electronic Program Guide (EPG) function of the master AV device 202 and/or the at least one slave AV device 204. If a user makes a request to view a broadcast program, for example using a remote controller, the master AV device 202 or the at least one slave AV device 204 amplifies a broadcast signal received from a content providing server, removes noise from the amplified broadcast signal, and transmits an AV signal corresponding to the noise-removed broadcast signal to a corresponding TV 206 on the channel desired by the user. The master AV device 202 having an HDD can record or store the broadcast services desired by the user. However, the slave AV device 204 without an HDD cannot store contents, but may share the contents stored in the master AV device 202.

While in an active state or active mode, the master AV device 202 periodically transmits its state information and content list to the slave AV devices 204. The slave AV devices 204 store the state information of the master AV device 202, received over the MoCA network, and update the content list. In order for the slave AV devices 204 to receive the state information and the content list of the master AV device 202, the master AV device 202 should be in an active state.

The user may select a desired content by searching the updated content list on the slave AV device 204. If the user requests the content he or she wants to view, the slave AV device 204 fetches the content stored in the master AV device 202 over the MoCA network, and transmits the fetched content to its TV 206.

On the other hand, when the master AV device 202 is in a standby state or an inactive state, the slave AV devices 204 cannot access the contents stored in the master AV device 202. In order for the slave AV devices 204 to access the contents, they should switch the state of the master AV device 202 to the active state. So, in order to access the contents stored in the master AV device 202 on the slave AV devices 204, the user should be able to identify the state of the master AV device 202 located in another place.

To this end, when switching from the active state to the standby state, the master AV device 202 transmits its current master AV state information and a content list to all the slave AV devices 204.

Each of the slave AV devices 204 stores the state information and the content list of the master AV device 202, received over the MoCA network. In an exemplary implementation, the slave AV device 204 may display the state of the master AV device 202. As to a method of displaying the state of the master AV device 202, the slave AV device 204 may display the state on a Light Emitting Diode (LED) device 208 mounted in the slave AV device 204, or on a screen of the TV 206 connected thereto. So, the user may identify the state of the master AV device 202 through the flickering LED device 208 mounted in the slave AV device 204 and the state displayed on the screen of the TV 206 connected to the slave AV device 204.

In order for the master AV device 202 to transmit its state information and content list to the slave AV device 204, the slave AV device 204 should be in an active state. Therefore, before switching from the active state to the standby state, the master AV device 202 identifies states of all the slave AV devices 204 connected thereto. If there are any slave AV devices in the standby state, the master AV device 202 should transmit master AV state information and content list after switching the slave AV devices in the standby state to the active state.

To this end, the master AV device 202 transmits a control signal for switching the slave AV devices in the standby state to the active state. The control signal may be created with one or more bits in a data frame.

Upon receiving the control signal, the slave AV device switches its state to the active state, and transmits an Acknowledgement (ACK) message to the master AV device. Upon receiving the ACK message, the master AV device transmits the master AV state information and the content list to the slave AV device. The master AV state information represents the standby state, which is the last state of the master AV device.

Upon normally receiving the master AV state information and the content list, the slave AV device transmits an ACK message to the master AV device. Upon receiving the ACK message, the master AV device transmits a control signal for switching the slave AV device, which was switched to the active state, back to the original state or the standby state. Upon receiving the control signal from the master AV device, the slave AV device switches its state to the standby state.

Meanwhile, the slave AV device having a specific timer may switch its state from the active state to the standby state if it does not operate for a predetermined time.

Through the above operation, the master AV device may transmit its state information and content list to all the slave AV devices, when transitioning from the active state to the standby state. In this way, the user may identify state information of the master AV device on the slave AV device and search a list of the contents stored in the master AV device, regardless of the state of the master AV device.

When the user wants to access the contents stored in the master AV device using the slave AV device, the user identifies the state of the master AV device by means of the LED device 208 or the screen of the TV 206. If the master AV device is in the active state, the user can enjoy the contents on the slave AV device. However, if the master AV device is in the standby state, the user should switch the state of the master AV device to the active state in advance in order to access the contents.

In controlling the state of the master AV device on the slave AV device, the user may use a switch mounted in the slave AV device, or an icon displayed on the screen of the TV connected to the slave AV device.

That is, if the master AV device is in the standby state, the user may switch the state of the master AV device to the active state by pressing a state transition switch 210 on the slave AV device. The user may also switch the state of the master AV device to the active state by pressing or clicking a state transition icon (not shown) displayed on the screen of the TV connected to the slave AV device. It will be understood by those of ordinary skill in the art that the user may remotely switch the state of the master AV device to the active state using a remote controller or the like.

If the user inputs a state transition command by means of the switch or the icon, the slave AV device transmits a control signal for switching the state of the master AV device. The control signal may be created with one or more bits in a data frame.

Upon receiving the control signal, the master AV device switches its state to the active state. After the state switching or state transition is completed, the master AV device transmits its current state information and content list to the slave AV device.

Upon receiving the state information and content list, the slave AV device displays the changed state information of the master AV device and updates the content list.

Through this operation, the user determines that the master AV device is in the active state, and then selects the content he or she wants to enjoy by searching the content list. If the user selects the content he or she wants to enjoy, the slave AV device fetches the content stored in the master AV device and transmits the fetched content to the TV connected thereto.

After completion of enjoying the content on the slave AV device, the user may switch the state of the master AV device to the standby state by pressing the state transition switch 210 on the slave AV device or the state transition icon on the screen of the TV. If the user inputs a state transition command by means of the switch or the icon, the slave AV device transmits a control signal for switching the state of the master AV device to the standby state.

Upon receiving the control signal, the master AV device switches its state back to the original state or the standby state. As described above, the master AV device transmits the last state information and the content list to the slave AV device before switching from the active state to the standby state. The slave AV device displays the state information and updates the content list.

Through the above process, the slave AV device may share the contents stored in the master AV device by remotely controlling the state of the master AV device.

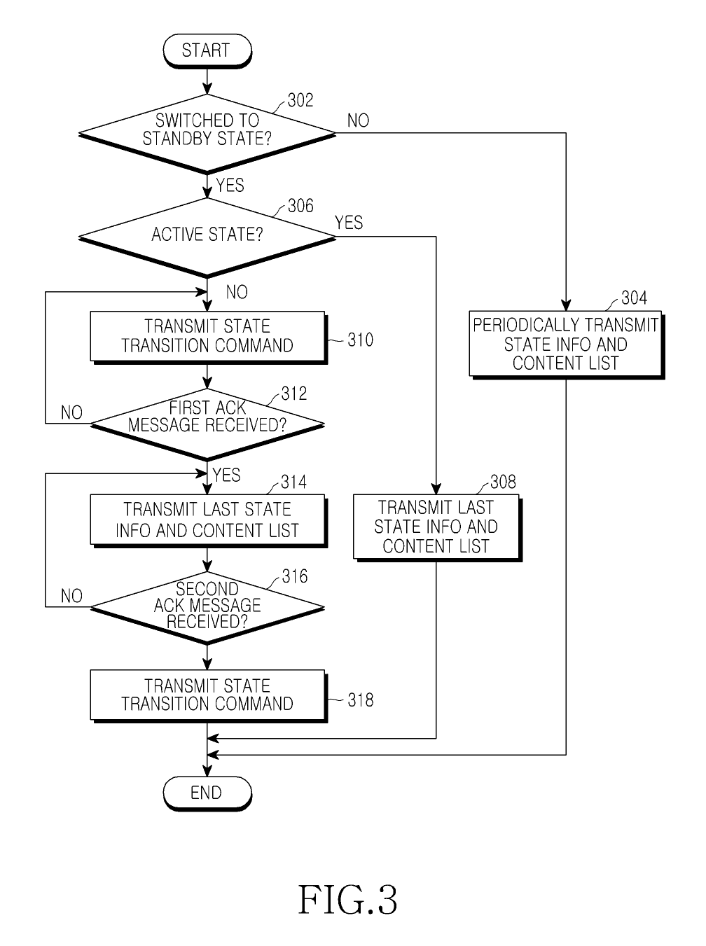

FIG. 3 is a flowchart showing an operation of a master AV device according to an exemplary embodiment of the present invention. In the process of FIG. 3, the master AV device transmits its state information and a content list to slave AV devices.

Referring to FIG. 3, the master AV device determines in step 302 whether its state has been switched from an active state to a standby state. If it is determined in step 302 that the master AV device remains in the active state, the master AV device periodically transmits the state information and the content list to the slave AV devices in step 304.

On the other hand, if is determined in step 302 that the master AV device has switched from the active state to the standby state, the master AV device determines in step 306 whether the slave AV devices are in the active state. The determination is carried out because the slave AV devices can receive the state information and the content list from the master AV device only when they are in the active state.

If it is determined in step 306 that the slave AV device(s) is in the active state, the master AV device transmits the last state information (representing the standby state) and the content list to the slave AV device in step 308.

However, if it is determined in step 306 that the slave AV device is in the standby state, the master AV device transmits a control signal to the slave AV device to switch the state of the slave AV device in the standby state to the active state in step 310.

The master AV device determines in step 312 whether a first ACK message indicating normal reception of the control signal is received from the slave AV device. If it is determined in step 312 that the master AV device fails to receive the first ACK message, the master AV device returns to step 310 and retransmits the control signal.

However, if it is determined in step 312 that the master AV device receives the first ACK message, the master AV device transmits the last state information (representing the standby state) and the content list to the slave AV device switched to the active state in step 314. After step 314, the master AV device determines in step 316 whether a second ACK message indicating normal reception of the state information and the content list is received from the slave AV device. If it is determined in step 316 that the master AV device fails to receive the second ACK message, the master AV device retransmits the last state information and the content list after returning to step 314.

However, if it is determined in step 316 that the master AV device receives the second ACK message, the master AV device transmits a control signal for switching the state of the slave AV device back to the original state in step 318.

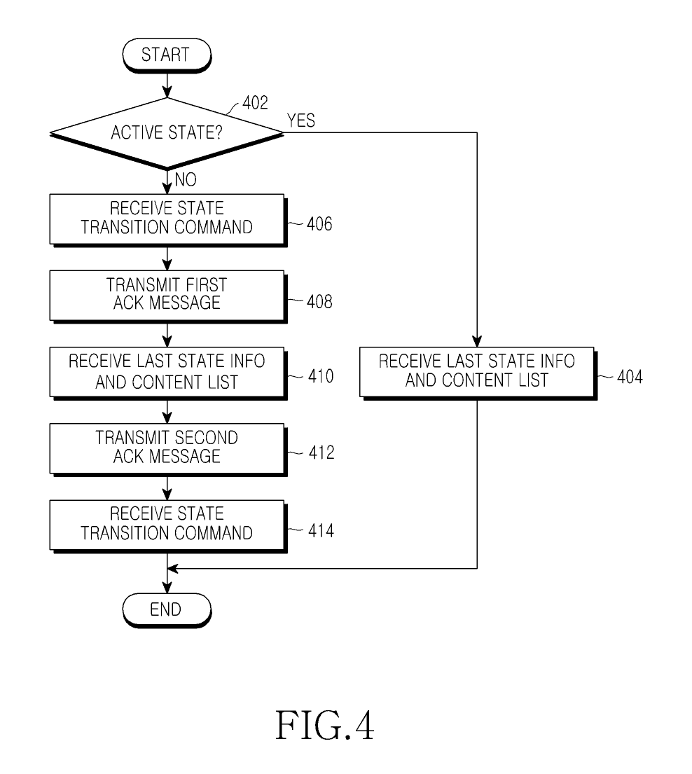

FIG. 4 is a flowchart showing an operation of a slave AV device according to an exemplary embodiment of the present invention. In the process of FIG. 4, the slave AV device receives state information and a content list from a master AV device.

Referring to FIG. 4, the slave AV device determines in step 402 whether its state is an active state. If it is determined in step 402 that the slave AV device is in an active state, the slave AV device receives last state information and a content list from the master AV device in step 404.

On the other hand, if it is determined in step 402 that the slave AV device is in a standby state, the slave AV device receives a state transition command from the master AV device in step 406. Upon receiving the state transition command, the slave AV device switches its state to the active state.

In step 408, the slave AV device transmits to the master AV device a first ACK message indicating normal reception of the state transition command.

In step 410, the slave AV device switched to the active state receives last state information and a content list from the master AV device. Upon normally receiving the last state information and the content list, the slave AV device transmits a second ACK message to the master AV device in step 412.

After completion of step 412, the slave AV device receives a state transition command from the master AV device in step 414. Upon receiving the state transition command, the slave AV device switches to the original state or the standby state.

Through the above processes, the master AV device may provide its state information and a content list to all slave AV devices. More particularly, when switching from the active state to the standby state, the master AV device may transmit its last state information and the content list to all slave AV devices. Therefore, the slave AV device can identify the state of the master AV device located in another place.

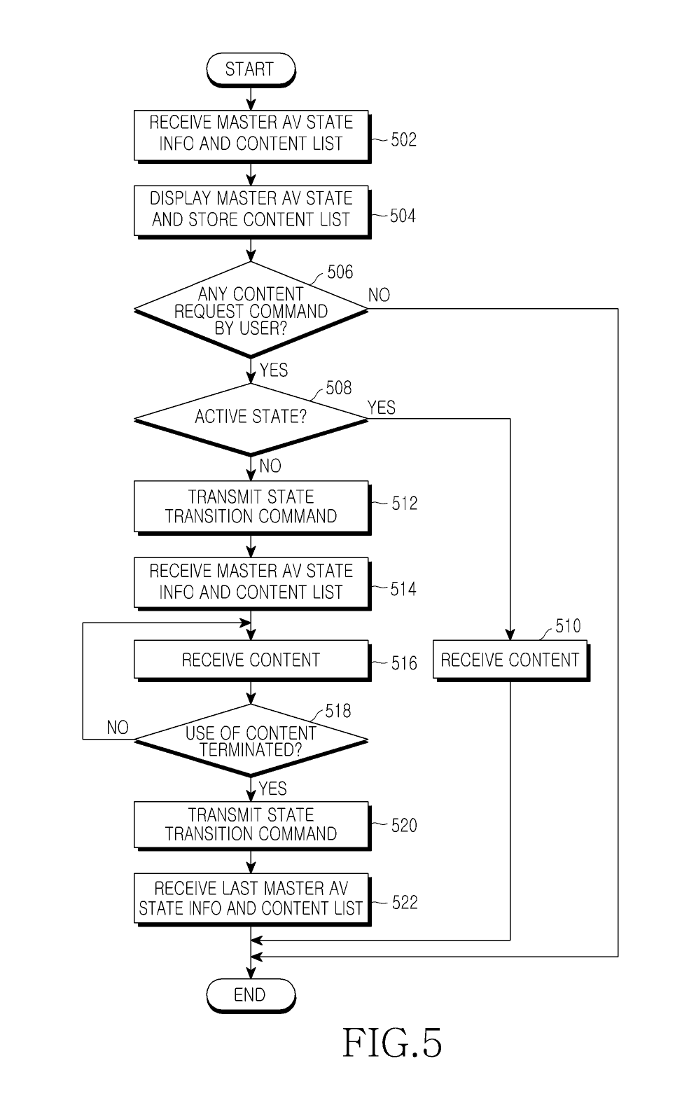

FIG. 5 is a flowchart showing an operation of a slave AV device according to an exemplary embodiment of the present invention. In the process of FIG. 5, at least one slave AV device controls a state of a master AV device to share contents.

Referring to FIG. 5, in step 502, the slave AV device receives state information and a content list from the master AV device. In step 504, the slave AV device displays the current state of the master AV device on an LED device or a TV screen, and stores the content list. The slave AV device having a built-in flash memory can store a small amount of data, like the content list.

In step 506, the slave AV device determines whether a content request command by a user is received.

If it is determined in step 506 that the slave AV device receives the content request command by the user, the slave AV device determines in step 508 whether the state of the master AV device is an active state. If it is determined in step 508 that the master AV device is in an active state, the slave AV device receives the contents stored in the master AV device over a MoCA network in step 510.

However, if it is determined in step 508 that the state of the master AV device is a standby state, the slave AV device transmits a control signal for switching the state of the master AV device to the active state in step 512. Thereafter, in step 514, the slave AV device receives current state information and a content list from the master AV device switched to the active state. The slave AV device displays the received state information and updates the content list.

In step 516, the slave AV device receives the content requested by the user, from the master AV device. The slave AV device transmits the received content to a TV connected thereto, allowing the user to enjoy the received content on the slave AV device.

In step 518, the slave AV device determines whether the use of the content by the user has been terminated. If it is determined in step 518 that the use of the content has not been terminated, the slave AV device returns to step 516 and continues to receive the content.

On the other hand, if it is determined in step 518 that the use of the content by the user has been terminated, the slave AV device transmits a control signal for switching the state of the master AV device back to its original state or the standby date, in step 520. Upon receiving the control signal, the master AV device transmits the last state information and the content list to the slave AV device before switching its state to the standby state. As a result, in step 522, the slave AV device receives the last state information of the master AV device and the content list.

By repeating the above process, the slave AV device can remotely control the state of the master AV device, making it possible for the user to conveniently enjoy the contents stored in the master AV device on the slave AV device.

As is apparent from the foregoing description, according to exemplary embodiments of the present invention, at least one slave subscriber terminal can control an operating state or an operation mode of a master subscriber terminal in a remote place, allowing the subscriber to more easily access the contents stored in the master subscriber terminal. The above and other aspects, features and effects of exemplary embodiments of the present invention are apparent from the foregoing description.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for remotely controlling a master subscriber terminal by a slave subscriber terminal in a home network, the method comprising:
requesting the master subscriber terminal to switch to an active state upon receiving a content request command input by a user while recognizing that the master subscriber terminal is not in an active state; and
providing the user with a content list based on content information provided from the master subscriber terminal, and receiving content data corresponding to a specific content selected by the user, from the master subscriber terminal.

2. The method of claim 1, further comprising requesting the master subscriber terminal to switch to a standby state if at least one of the reception of the content data corresponding to the specific content from the master subscriber terminal is completed and termination of the use of the specific content is requested by the user.

3. The method of claim 2, further comprising receiving updated content information from the master subscriber terminal after requesting the master subscriber terminal to switch to the standby state.

4. The method of claim 1, wherein the master subscriber terminal and the slave subscriber terminal comprise Audio/Video (AV) devices sharing content data based on a Multimedia over Coax Alliance (MoCA) network.

5. The method of claim 4, further comprising displaying a current state of the master subscriber terminal.

6. A home network system including at least one slave subscriber terminal and a master subscriber terminal, the system comprising:
the master subscriber terminal for identifying a state of the at least one slave subscriber terminal, and if the at least one slave subscriber terminal is in a standby state, for switching the state of the at least one slave subscriber terminal to an active state and transmitting its state information and a content list; and
the at least one slave subscriber terminal for requesting the master subscriber terminal to switch to an active state upon receiving a content request command input by a user while recognizing that the master subscriber terminal is not in the active state, for providing the user with a content list provided from the master subscriber terminal, and for receiving content data corresponding to a specific content selected by the user, from the master subscriber terminal.

7. The system of claim 6, wherein the master subscriber terminal periodically transmits state information and a content list to the at least one slave subscriber terminal if the slave subscriber terminal is in an active state.

8. The system of claim 6, wherein the master subscriber terminal switches a state of the at least one slave subscriber terminal switched to the active state to a standby state upon receiving a message indicating normal reception of the state information and the content list, from the at least one slave subscriber terminal.

9. The system of claim 6, wherein the at least one slave subscriber terminal requests the master subscriber terminal to switch to a standby state if at least one of the reception of the content data corresponding to the specific content from the master subscriber terminal is completed and termination of the use of the specific content is requested by the user.

10. The system of claim 9, wherein the at least one slave subscriber terminal receives updated content information from the master subscriber terminal after requesting the master subscriber terminal to switch to a standby state.

11. The system of claim 6, wherein the master subscriber terminal and the at least one slave subscriber terminal comprise Audio/Video (AV) devices sharing content data based on a Multimedia over Coax Alliance (MoCA) network.

12. A method for operating a home network system including at least one slave subscriber terminal and a master subscriber terminal, the method including:
receiving, by the at least one slave subscriber terminal, a content request command;
determining, by the at least one slave subscriber terminal, if the master subscriber terminal is in an active state;
transmitting, by the at least one slave subscriber terminal, a first state transition command to the master subscriber terminal if the master subscriber terminal is not in the active state; and
receiving, by the at least one slave subscriber terminal, content from the master subscriber terminal.

13. The method of claim 12, further comprising receiving, by the at least one slave subscriber terminal, updated content information from the master subscriber terminal after transmitting the first state transition command.

14. The method of claim 12, further comprising transmitting, by the slave subscriber terminal, a second state transition request to the master subscriber terminal to switch to a standby state if the reception of the content from the master subscriber terminal is completed.

15. The method of claim 12, further comprising:
determining, by the master subscriber terminal, if it its state has been switched from an active state to a standby state;
transmitting, by the master subscriber terminal, a third state transition command to the at least one slave subscriber terminal if the at least one slave subscriber terminal is in an inactive state;
transmitting, by the master subscriber terminal, a content list to the at least one slave subscriber terminal; and
transmitting, by the master subscriber terminal, a fourth state transition command to the at least one slave subscriber terminal.

16. The method of claim 15, further comprising:
receiving, by the master subscriber terminal, a first Acknowledgement (ACK) message from the at least one slave subscriber terminal in response to the third state transition command; and
receiving, by the master subscriber terminal, a second ACK message from the at least one slave subscriber terminal in response to reception of the content list.
